(19) United States
(12) Patent Application Publication
(10) Pub. No.: US 2013/0085862 A1
(43) Pub. Date: Apr. 4, 2013

(54) SYSTEM AND METHOD FOR DISTRIBUTING ADVERTISEMENTS ON A NETWORK IN ACCORDANCE WITH A TIERED PERIODIC DELIVERY GOAL

(71) Applicants: Bret GORSLINE, Flemington, NJ (US); Evguenia Freider, Bridgewater, NJ (US); Boris Friedman, Upper Saddle River, NJ (US)

(72) Inventors: Bret GORSLINE, Flemington, NJ (US); Evguenia Freider, Bridgewater, NJ (US); Boris Friedman, Upper Saddle River, NJ (US)

(21) Appl. No.: 13/253,019

(22) Filed: Oct. 4, 2011

(51) Int. Cl. G06Q 30/00

(52) U.S. Cl. 705/14.61

(57) ABSTRACT

A system and method for selecting advertisement lines to serve advertisement requests on a network. According to some embodiments, a ranking system or methodology is implemented to select advertisement lines in a manner that paces the respective advertisement line for a successful outcome.

### TECHNICAL FIELD

Embodiments described herein relate to a system and method for distributing advertisements on a network in accordance with a tiered periodic delivery goal.

### BACKGROUND

Advertisement management systems currently exist in various forms to manage distribution of advertisement content on a network. Such advertisement management systems typically have to accommodate various competing interests, such as the interest of a single advertiser over that of other advertisers, or their own interest over that of the advertisers. The ability of the operator to maintain campaigns relatively current and on-track for completion can be a challenge, given the various interests of the parties involved, as well as the dynamic nature of networks on which the advertisement content is served. In stressed operating conditions, such as when advertisement lines are oversold, the various competing interests can cause the advertisement management system to lose efficiency and effectiveness.

### BRIEF DESCRIPTION OF THE DRAWINGS

FIG. 1 illustrates an advertisement management system for selecting advertisement lines to serve advertisement requests received over a network, according to one or more embodiments.

FIG. 2 illustrates a method for selecting an advertisement line to service a request received from over a network, according to one or more embodiments.

FIG. 3 illustrates a more detailed method for selecting an advertisement line to serve an advertisement request, according to an embodiment.

FIG. 4 illustrates a method for pacing an advertisement line in accordance with a tiered ranking approach, according to one or more embodiments.

FIG. 5 illustrates a method for determining a priority value for individual advertisement lines that comprise an inventory of advertisement lines, according to one or more embodiments.

FIG. 6 is a block diagram that illustrates a computer system upon which embodiments described herein may be implemented.

### DETAILED DESCRIPTION

Embodiments described herein include a system and method for selecting advertisement lines (“ad lines”) to serve advertisement requests on a network. According to some embodiments, a ranking system or methodology is implemented to select ad lines in a manner that paces the respective ad line for a successful outcome. According to additional or alternative embodiments, a prioritization schema is developed to prioritize the selection of ad lines. The prioritization schema may be used either independently of considerations for pace, or in connection with a ranking methodology to maintain a successful pace for individual ad lines.

In an embodiment, advertisement lines are selected to distribute advertisement media based on a prioritization schema. A priority value is determined for each of a plurality of advertisement lines that comprise an inventory of advertisement lines. The priority value for each advertisement line is determined by considering a classification for each advertisement line that is selected from two or more possible classifications, where the classification is based at least in part on whether the advertisement line is required to generate a designated number of delivery units in a given duration. Additionally, the priority value is determined by considering one or more sub-values for each advertisement line. The one or more sub-values include at least one of (i) an end date value that is associated with an end date of the advertisement line, or (ii) a scarcity value that is indicative of a relative scarcity of an intended class of targets for the advertisement line. The priority value is determined based at least in part on the classification and the one or more sub-values. An advertisement line is selected from the inventory of advertisement lines in accordance with a priority schema that is based at least in part on the priority value associated with each of the plurality of advertisement lines.

In another embodiment, a ranking for individual advertisement lines of an inventory is determined. The ranking is based at least in part on a pace for which delivery units of that advertisement line are to be generated in order for the advertisement line to generate a required number of delivery units for that advertisement line in a designated duration. In some embodiments, the ranking for each advertisement line is based at least in part on the number of delivery units required to meet a defined portion of the goal guaranteed within a designated duration. A prioritization value is also determined for the individual advertisement lines, based on (i) a classification that is indicative of a number of delivery units that are required to be generated for that advertisement line in a designated duration; (ii) one or more sub-values for each advertisement line that correlate to a predefined prioritization parameter. In particular, the predefined prioritization parameters may correspond to one or more of (i) a network location where advertisement media for the advertisement line are distributed, (ii) a target for the advertisement line, or (iii) a remainder of the designated duration in which advertisement media for the advertisement line are to be distributed on the network. In response to receiving a request, an advertisement line is selected from the inventory based at least in part on the ranking and the prioritization values of the individual advertisement lines.

Still further, another embodiment provides for determining a total number of delivery units that are to be generated for an advertisement line over a duration of time that includes a defined start time and a defined end time. For each of a plurality of time segments that comprise the duration of time, a required portion of the total number of delivery units is determined, based on a proportionate distribution of at least some of the total number of delivery units over each of the plurality of time segments. At a given instance in the duration of time, at least one of an actual or predicted deficit is determined to the total number of delivery units. Delivery of advertisement content is initiated to generate delivery units for the advertisement line by (i) assigning a higher priority to delivering advertisement content in each time segment to generate the required portion of the total number of delivery units, and (ii) assigning a lower priority to delivering advertisement content in each time segment to generate a surplus to the required portion. The surplus is counted against the deficit to the total number of delivery units.

Among other benefits, embodiments described herein enable an advertisement management system to be more flexible in how ad lines are selected in relation to other ad lines. The added flexibility enables an advertisement management system to better handle, for example, oversold situations. Additionally, embodiments such as those described avoid overuse of network traffic projections, and further enable better monetization from a given inventory of ad lines.

According to some embodiments, the prioritization and/or ranking methodologies may be adjustable in real time to account for variations in network resources, requirements of specific advertisers, or other events or conditions.

### DEFINITIONS

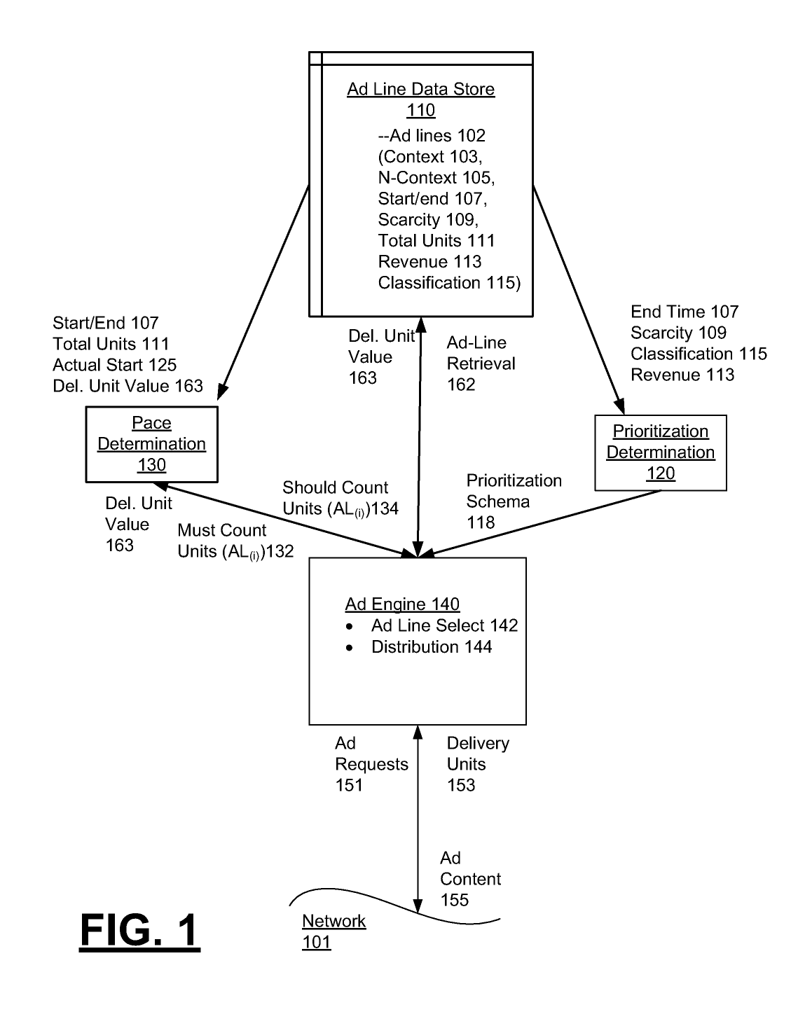

As used herein, an “advertisement line” (or “ad line”) refers to an obligation incurred on the part of an advertisement management system (e.g., see FIG. 1) to generate a known or unknown (e.g., estimated) quantity of delivery units for a given advertisement content or media.

A “delivery unit” refers to a defined interaction between a user and an advertisement content or media. Specific examples of delivery units include unique users or impressions, clicks, mouse-overs or combinations thereof.

A “channel” refers to a delineated segment of a network, such as a domain, sub-domain, or network service provided on a network.

The term “pace” refers to a frequency in which an advertisement line needs to deliver on a network, particularly as to whether the advertisement line is on track to complete its delivery unit goal for a given duration of time. As described by embodiments, “pace” (e.g., “an advertisement line maintains pace . . . ”) can reflect both a substantially even distribution of periodic goals for delivery units, as well as a skewed or loaded distribution of such periodic goals (e.g., front loaded or with deficit accumulation).

One or more embodiments described herein provide that methods, techniques and actions performed by a computing device are performed programmatically, or as a computer-implemented method. Programmatically, as used herein, means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be stored on a computer-readable medium. Machines shown or described with figures below provide examples of processing resources and computer-readable mediums on which instructions for implementing embodiments of the invention can be stored and/or executed. In particular, the numerous machines shown with embodiments described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as provided on many cell phones and tablets), and magnetic memory. Computers, terminals, network enabled devices (e.g., mobile devices such as cell phones) and tablets are all examples of machines and devices that utilize processors, memory, and instructions stored on computer-readable mediums. Additionally, embodiments may be implemented in the form of computer-programs, or a computer usable medium capable of storing instructions for such a program.

### System Architecture

FIG. 1 illustrates an advertisement management system for selecting advertisement lines to serve advertisement requests received over a network, according to one or more embodiments. An advertisement management system such as described with an embodiment of FIG. 1 can be implemented by components that execute on a network, such as one controlled by an entity that manages advertisement inventory on a network and distributes advertisement content accordingly. The advertisement management system 100 may be implemented by one or more computers, such as one or more servers that manage advertisement inventory or one or more networks.

According to one or more embodiments, system 100 includes an ad line data store 110, a prioritization determination component 120, a pace determination component 130, and an ad engine 140. The ad line data store 110 stores an inventory of advertisement lines, such as campaigns for presenting advertisement content (e.g., banner ads, polls, video clips) to users of the network 101. Each advertisement line may be associated with one or more advertisement content (e.g., banner ads, polls, video clips), as well as various parameters that specify when (e.g., how often, for whom, in what context) and where (e.g., which website, channel or portion of a network) the advertisement content is to be displayed.

More specifically, the individual advertisement lines can be associated with various parameters that can be used to select and manage advertisement lines. The parameters can be determined from requirements and other input specific by the advertiser. For example, advertisers may have the ability to specify parameters in the ad line that identify start/end times, total number of delivery units that the ad line is to generate, the classification of the ad line in terms of whether the delivery units that are to be generated are guaranteed or not, information about the target audience, and/or information about the portion of the network in which the ad line is to be provided on. Monetization parameters may also be associated with ad lines depending on pricing rules provided from the operator of system 100, as well as negotiations between advertiser and operator. More specific examples of parameters that can be associated with the advertisement lines include: (i) contextual parameters 103, which can be used to specify a context (e.g., specific or type of website or domain, topic of webpage etc.) in which advertisement content or media from an advertisement line can be displayed; (ii) non-contextual parameters 105, including parameters that specify, for example, a target audience for the content of the advertisement line; (iii) start and end time 107, which refers to a scheduled start and end time for an advertisement line; (iv) scarcity 109, which identifies the commonness (or lack thereof) of a specific audience for an advertisement line 102; (v) total delivery units 111 that are to be generated from the ad line during its flight time (e.g., until the end time); and/or (vi) revenue 113 (e.g., cost-per-impression) associated with delivering content for the advertisement line.

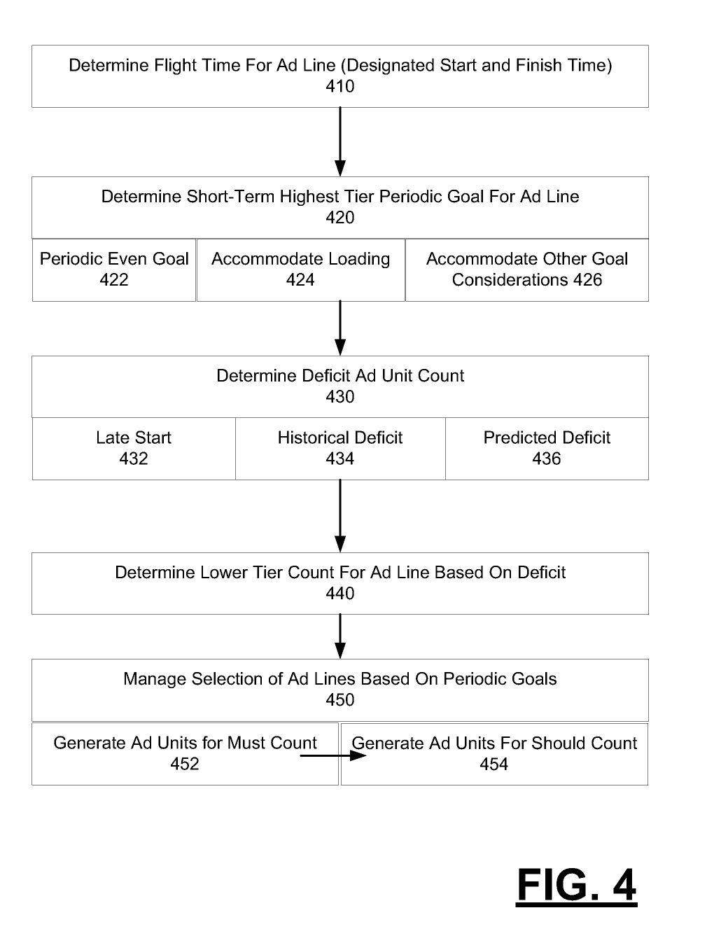

The prioritization determination component 120 determines a prioritization schema 118 for use in selecting which ad lines 102 are to be selected for serving ad requests. As described with some other embodiments, the prioritization schema 118 can be used to select ad lines 102 for requests in combination with rankings that are based on periodic goals of an ad line 102. As described with, for example, an embodiment of FIG. 4, the periodic goals of an ad line is based on a determination as to how the ad line is to maintain pace in order for individual ad lines to achieve their respective total goals of delivery units in an efficient and effective manner. The prioritization determination can be based on, for example, the ad line classification 115, as well as various parameter sub-values such as the end time 107, scarcity 109, and/or revenue 113.

The pace determination 130 determines short or periodic (e.g., daily delivery goal) goal values for delivery of delivery units for individual ad lines 102. The short or periodic goal values can be determined from parameters that include the ad line's start and end time 107, as well as the total number of delivery units 111 that are to be generated for the ad line 102. In addition, the periodic goal values can factor in values determined during the ad line's flight time, including (i) the actual start date 125 for an ad line 102, which can differ from the scheduled start date (e.g., such as due to advertiser delay); and (ii) the number or value of delivery units 163 to date from for the ad line 102. The value of the delivery units 163 may alternatively be communicated from the ad engine 140.

In an embodiment, pace determination component 130 determines the periodic goals using a tiered count for each advertisement line. In one implementation, a two-tiered count is used for each ad line 102, identifying, for a given period of time (e.g., day) a high priority (e.g., “must”) count 132, and a low priority (e.g., “should”) count 134 for the individual ad line 102. In alternative variations, three or more tiers may be used to determine the periodic goal for each advertisement line. As described elsewhere, some embodiments determine ranking values for the individual ad lines 102 based on which tiered goal(s) the ad line is fulfilling in a given instance of a defined period (e.g., day). The tiered goals for the individual ad lines may be based in part on the pace desired (or deemed required) for the ad line to be adequately fulfilled for its flight time. The ranking values, in combination with the prioritization schema 118, can be used to select advertisement lines 102 in response to requests received over the network 101.

The ad engine 140 selects individual ad lines 102 for serving ad requests 151 received over the network 101. The network 101 can correspond to, for example, a domain or website, a collection of domains or websites under the control or operation of a single entity (e.g., corporation), or numerous domains or websites operated by different entities. The ad requests 151 can be communicated in response to events, such as browsing events (e.g., page downloads) from end users. An ad line selection component 142 includes logic for selecting ad lines 102 in response to the ad requests 151. A distribution component 144 of the ad engine 140 distributes (or causes the distribution of) ad content 155 associated with selected ad lines 102 onto the network 101, so that the ad content 155 are delivered to individual terminals which communicate requests. The end user interaction with the ad content 155 generates the delivery units (e.g., impressions or clicks). The ad content 155 can correspond to, for example, media (e.g., images accompanying text like such as presented by banner ads, and dynamic media (video, Flash or HTML5 resource, etc.)), which are associated in the data store 110 with a specific ad line 102.

According to embodiments, the selection logic 142 of the ad engine 140 is configured to algorithmically select a specific ad line 102 to serve individual requests 151 based on various parameters or criteria. According to embodiments, the selection logic 142 performs processes for selecting ad lines 102 using parameters that are based on (i) ad line prioritization, as provided by the prioritization schema 118; (ii) ranking as determined by the individual ad lines progress in completing its tiered goals (e.g., high-ranking 132 and lower ranking count 134), for a given period of time; and (iii) other ad line criteria, which can be set forth by, for example, contextual or non-contextual parameters of the individual ad lines 102. In one implementation, the ad engine 140 signals ad line retrieval 162 of the ad content 155 associated with the selected ad line 102 in response to selecting that ad line for serving a given ad request 151. With distribution of the ad content 155, the ad engine 140 may also be configured to detect or receive resulting delivery units 153, which can correspond to, for example, page-downloads or impressions, clicks, flyovers, or other end-user interactions or events that are counted for the purpose of monetizing, or otherwise quantifying the effectiveness of the delivered add content 155. The ad engine 140 may communicate the delivery unit value 163, to the data store 110 and/or to the pace determination 130. The delivery unit value 163 represents the delivery units 153 generated from selection of an individual ad line 102 and distribution of corresponding ad content 155.

### Methodology

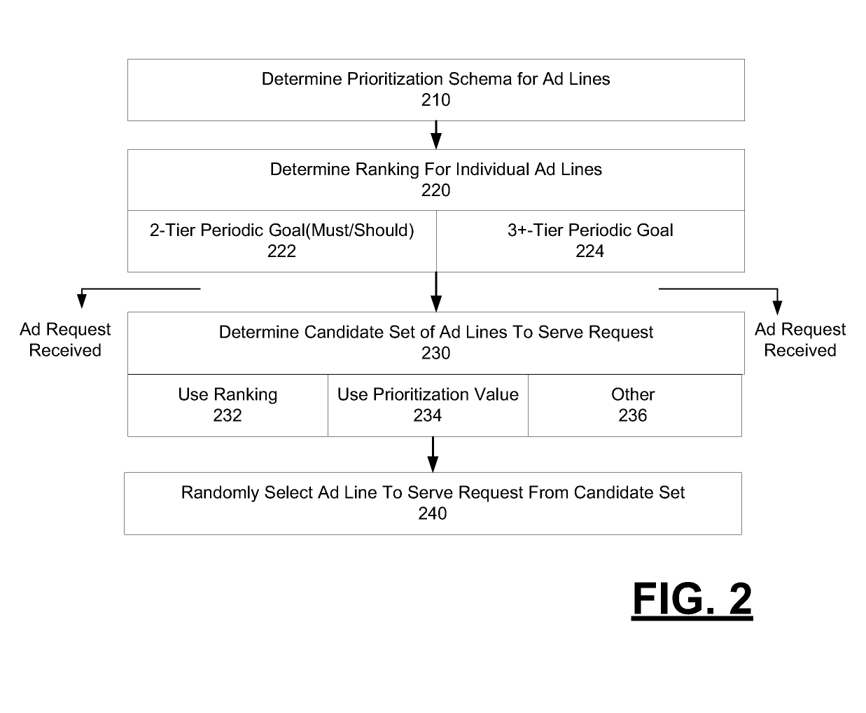

FIG. 2 through FIG. 5 illustrate processes for use in selecting ad lines 102, according to one or more embodiments. In describing the embodiments of FIG. 2 through FIG. 5, reference may be made to elements described with system 100 for purpose of illustrating suitable components or elements for performing a step or substance being described.

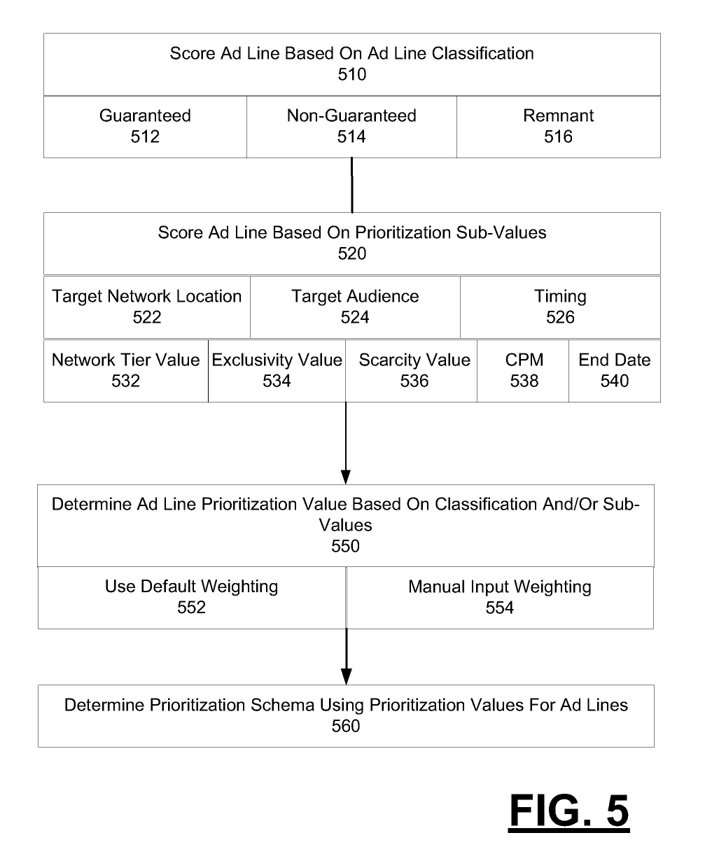

FIG. 2 illustrates a method for selecting an ad line to service a request received from over the network 101, according to one or more embodiments. The prioritization schema 118 may be determined for individual ad lines 102 of a given inventory (e.g., stored in the date store 110) (210). As described in greater detail, the determination of the prioritization schema 118 may be based on various parameters associated with the individual ad lines 102. For example, as described with an embodiment of FIG. 5, the prioritization determination component 120 can be configured to determine a priority value for individual ad lines, relative to other ad lines in the inventory, based on classification(s) and other selected values (e.g., “prioritization sub-values”).

In addition to the prioritization schema 118, a ranking is determined for individual ad lines (220). The ranking determination may be based at least in part on the number of delivery units required to meet a defined portion of the goal guaranteed within a designated duration. The ranking may reflect short-term or longer-term goals (e.g., daily) for meeting an ad line's requirement for generating a total number of delivery units 153 over the course of the ad line's flight time. Other considerations, such as a desire to evenly distribute the delivery units generated from each ad line, or load a portion of the required ad line to one portion of the flight time may also factor into determining the short and long term goals of the individual ad lines.

According to some embodiments, the rankings may be based on short-term periodic goals that are tiered. In one embodiment, a two-tiered periodic goal is used (222). In the two-tiered approach, that short-term periodic goals are identified by a high-ranking goal (e.g., “must-count”) and a low-ranking count (e.g., “should-count”). As an alternative variation, a three or more tiered periodic goal may be used (224). According to embodiments, the individual ad lines are selected over the course of a period (e.g., day) to generate delivery units 153 that satisfy at least the high tier goal for the ad line. Once the high-tier goal is on-pace for a given ad line, the selection of the ad line is based on the lower tier goal for the ad line. According to some embodiments, the fulfillment of the lower tier goal for the ad line is initiated when the higher tiered goals for all other ad lines under consideration are on pace. As described with some embodiments, demotion of the ad line in rank may result in the ad line being selected less frequently, so that lesser ranked ad lines are selected less frequently.

Various algorithms or considerations may be employed for utilizing mufti-tiered periodic goals. For example, in a two-tiered periodic goal implementation, the ad engine 140 selects the ad lines for a given period of time (e.g., day) using a ranking value that is based on which goal the ad line has met in a given period of time.

A candidate set of ad lines can be determined for purpose of selecting ad lines to serve individual requests at a given time (230). The candidate set of ad lines may be determined by factoring in the ranking of individual ad lines (232), the prioritization value of the individual ad lines (234), and/or other requirements, such as contextual or scheduling requirements specified for an individual ad line (236).

The ad engine 140 may serve an ad request by selecting an ad line from the candidate set (240). In one embodiment, the selection of an ad line from the candidate set is made randomly. In other embodiments, the selection of an outline from the candidate set is made algorithmically, using, for example, parameters or other considerations.

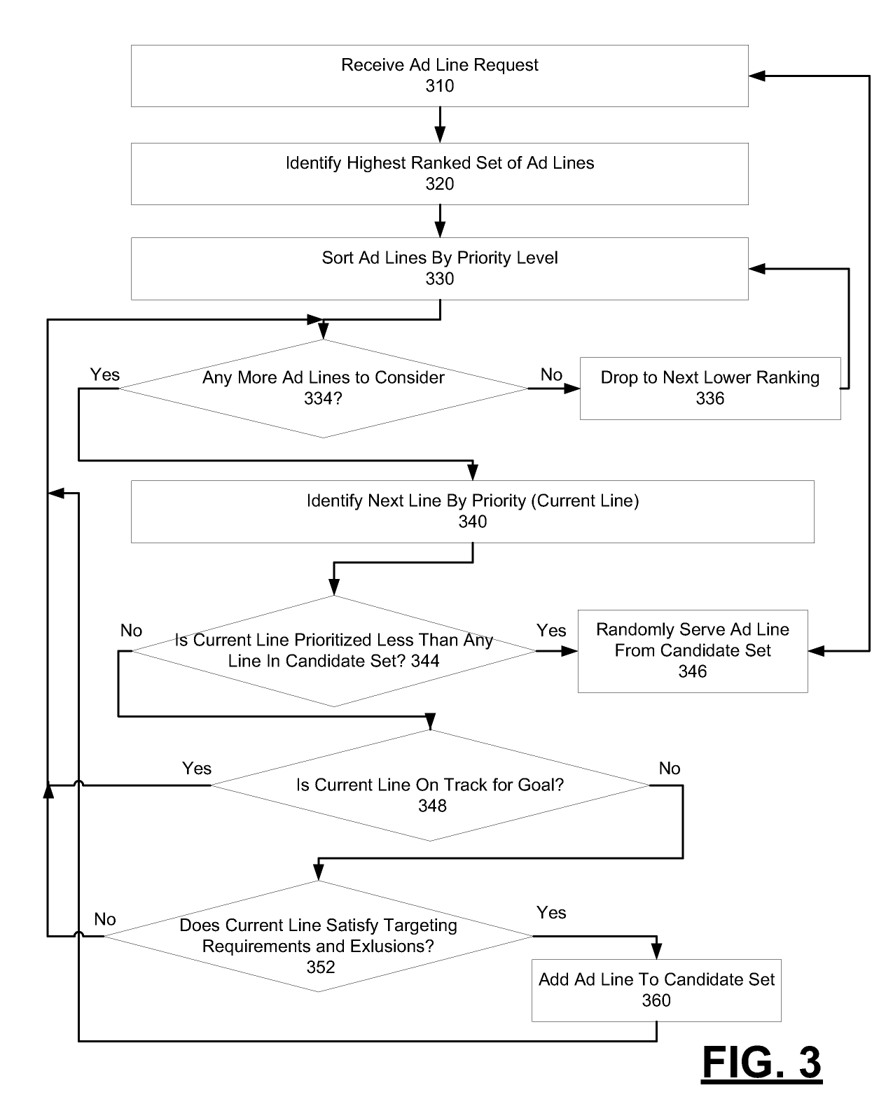

FIG. 3 illustrates a more detailed method for selecting an ad line to serve an ad request, according to an embodiment. With reference to FIG. 3, an ad request is received from network 101 (310). The ad request may be generated in response to an event such as, for example, a download request for a webpage. In response to receiving the request, a highest ranked set of available ad lines is identified. A ranking process such as described by an embodiment of FIG. 4 may be employed to determine a set of ad lines that have the highest ranking.

For example, an ad line may be associated with the highest ranking in response to (i) the ad line having yet to fulfill a “must” portion of its daily goal, or (ii) the ad line not being on-pace to fulfill the “must” portion of its daily goal. The ad lines in the highest rank set are then sorted by a priority schema, such as provided by a priority value associated with individual ad lines (320). A prioritization process such as described by an embodiment of FIG. 5 may be employed to prioritize ad lines in the ranked set.

Following the highest rank set being prioritized, a determination is made as to whether more than one ad line exists in the set (334). If no ad lines exist in the set, then the ranking is dropped (336), so that the ad lines having the next highest ranking are identified, and the method is repeated by prioritizing the newly identified set at (330). If, however, the determination of (334) is that at least one ad line exists in the set, then a current ad line is determined based on the priority associated with the current ad line relative to other ad lines (if any) in the set (340).

A determination is made as to whether the current ad line is prioritized below any line in a candidate set of ad lines (344). If no ad lines exist in the candidate set (e.g., such as when the process described in FIG. 3 is performed for the first time), then the determination of (344) is negative. Likewise, if the current ad line is prioritized above any ad line in the candidate set, the determination of (344) is also negative. If the determination of (344) is negative, another determination is made as to whether the current ad line is on track for its short-term goal (e.g., periodic or daily goal) (348). If the current ad line is on pace, then the process is repeated at (340), so that a new current ad line is determined for highest ranked set. Accordingly, under an implementation such as described, ad lines are added to the candidate set when, for example, the ad lines must-goal are not on pace.

If the current ad line is not on pace, then the current ad line may be added to the candidate set of ad lines. In one implementation, another determination is made as to whether serving the current ad line for the open ad request would meet the targeting requirements and exclusions specified for the current ad line (352). For example, as mentioned with an embodiment of FIG. 1, an ad line may have contextual or non-contextual requirements. If the open ad request satisfies the various requirements of an ad line, then the ad line is added to a candidate set (360). The method repeats from the determination of (334).

As noted by an embodiment of FIG. 2, some embodiments select ad lines to serve the open request based on a random selection from the candidate set. Accordingly, with reference to FIG. 3, after an ad line is selected for the candidate set, the determination of (334) is repeated. After iteration (or multiple possible iterations), the determination of step (334) is that no other ad lines exists for the particular ranking, resulting in lower-tiered rankings being considered (336). The next level becomes the highest tiered ranking, and a set of ad lines are identified for that ranking at (320). The set is sorted based on the prioritization schema (330). At (334), the determination is made as to whether any ad lines remain in the set. The current line is identified based on priority (340), and a determination is made as to whether the current line is prioritized less than all of the other ad lines in the candidate set (344). For example, the priority value may be determined for the current ad line (e.g., see an embodiment of FIG. 5), and then compared with the priority value of the ad lines that comprise the candidate set.

When the determination of (344) is positive (e.g., current ad line has lesser prioritization value the prioritization value of each ad line in the candidate set), an ad line is selected from the candidate set is randomly selected and served for the open request (346). As noted, this random selection coincides with the current ad line being lesser in rank than the ad lines of the candidate set. For example, once the candidate set is developed based on comparisons of prioritization values amongst ad lines, an ad line is selected from the candidate set to serve the ad request. In this way, the process for selecting ad lines incorporates (i) consideration for meeting periodic or short-term goals, (ii) prioritization, (iii) requirements or considerations for individual ad lines (e.g., contextual or non-contextual requirements), and (iv) randomness.

Maintaining Pace with Short-Term Goals

FIG. 4 illustrates a method for pacing an ad line in accordance with a tiered ranking approach, according to one or more embodiments. An embodiment of FIG. 4 provides for establishing tiered periodic goals for individual campaigns. More specifically, as noted with an embodiment of FIG. 1 and elsewhere in this application, the periodic goal of an ad line may be tiered for a given duration, so that each ad line has periodic goals that range in importance. For example, in a two-tiered approach, each ad line may have a “must-count” and a “should-count.” The “must-count” reflects the number of delivery units that should be generated if at all possible for a given period of time (e.g., day). According to an embodiment, all ad lines are on pace to deliver their “must-count” before any lower priority goals are delivered. The “should-count” reflects the number of delivery units that can be generated, assuming there are no conflicts with higher tier goal components (i.e., those ad lines that are completing their “must-count”). When an ad line is completing its “should-count”, it is associated with a lower ranking. Additionally, in some implementations, the guaranteed ad lines are on pace to deliver their “should-count” before other classifications such as discretionary or remnant are initiated for delivery. While two-tiered approach is described with an embodiment of FIG. 4, other embodiments may extend the approach to use of three or more tiered periodic goals, so as to further introduce robustness and flexibility into the manner in which ad lines are selected to serve open ad requests. Still further, other goal components (426) may be considered, such as based on determined fragments of deficits incurred to the present time.

With reference to FIG. 4, the manner in which an ad line is paced includes determining the flight time for an ad line (410). The flight time can correspond to the start and finish time for an ad line. The start and finish time may be specified as parameters of the ad line by way of, for example, a contractual obligation between the advertiser and the operator of, for example, advertisement management system 100. In many real-world situations, the start time may differ from the actual start time, for reasons such as unforeseen delay in initiating the ad line.

For given ad line, a short-term, highest tier periodic goal is determined corresponding to the number of delivery units that are to be generated for the particular ad line in a designated duration of time (420). In an embodiment, the highest-tier periodic goal reflects a determined threshold requirement that is to be satisfied on a periodic basis throughout the flight time of the ad line, and correlates to the ability for the ad line to generate a sufficient number of delivery units to satisfy its long-term requirement (e.g., total number of impressions required for an ad line). In one implementation, a periodic even goal may be determined (422) in which the total number of delivery units required for the ad line is distributed substantially evenly over each period in the flight time. As an addition or alternative, a portion of the flight time for the ad line may be designated as being loaded (424)—meaning that a disproportionate number of delivery units are designated to be generated over a specific portion of the flight time. For example, an ad line may be frontloaded, so that a disproportionately larger portion of the total delivery units required from the ad line are generated in a front portion (e.g., first five days, or days 2 through 7 etc.) of the total flight time (e.g., 30 days).

In order to pace an ad line, one or more embodiments provide for determining a deficit in the delivery units that are (or will be) generated from the ad line (430). The deficit determination may be determined in flight, and optionally on an ongoing or periodic basis. In one implementation, the deficit determination accounts for whether the ad line had a late start (432). For example, ad lines are often designated to be initiated on a given day, but can suffer a delay in initiation for a variety of reasons, such as delay by advertiser in providing the advertisement content or media associated with the ad line. In the case of a late start, a deficit may be incurred disproportionately each day that the ad line was supposed to run, but did not. In another implementation, the deficit determination accounts for a historical deficit incurred by the ad line during its flight time (434). For example, the ad line may run during a time when there is low traffic or too much inventory with respect to the advertisements available. Still further, deficit determination makes a prediction of the future deficit in a given ad line (436). For example, a prediction that a deficit will be incurred may be based on anticipation of low traffic (e.g., observance network traffic patterns), or the observance of a future event which will cause low traffic (e.g., a holiday).

The deficit determination is used to determine a next or lower tier count (e.g., “should-count”) for the ad line (440). According to some embodiments, when an ad line is generating delivery units for its lower tier count, the system 100 will likely select the ad line less frequently, so that, for example, if there is an oversold situation, it generates delivery units at a slower pace. In one implementation, the lower tier count is also segmented into periodic goals based on an accumulated and/or predicted deficit in the delivery units for the ad line. The periodic lower tiered goals may be determined from the total accumulated and/or predicted deficit, divided by either (i) a total number of periods in the flight time of the ad line, or (ii) a total number of periods in a remaining portion of the flight time for the ad line.

For given ad line, the deficit determination for an ad line is used to manage the delivery of ad content associated with that ad line in order to generate delivery units such as impressions or clicks (450). In a two-tiered implementation, individual ad lines are selected at a pace that is based on the magnitude of the “must-count” (452) or “should-count (454) goal components. The ranking of individual ad lines progress from a highest ranking, coinciding with the ad line being in process of completing its highest tier goal, to a lowest ranking, coinciding with the ad line having completed all higher tiered goals. In variations in which three or more tiers are used, the pace in which an ad line is selected may be varied for each tier.

Accordingly, an embodiment such as described with FIG. 4 enables ad lines to be ranked based on which goal the ad line is fulfilling at a given instance. In a given period (e.g., day), an ad line will deliver against its top-tier goal until it's considered on-pace, at which point lower-tiered goal components may be delivered. The amount of time a given ad line takes to deliver its top-tier goal can depend on factors such as the total number of impressions that the ad line is required to serve over its life, as well as the ease (e.g., lack of restrictions associated with the ad line) in which the ad line can be selected for an request.

A ranking methodology as described provides one mechanism to enable the selection of ad lines for ad requests received over a network. The ranking methodology can be used as a primary mechanism for selecting ad lines to serve ad requests. Alternatively, as described with some other embodiments, the ranking methodology may be combined with other selection techniques, including prioritization (e.g., see FIG. 5). Additionally, as described with, for example, an embodiment of FIG. 2, the ranking methodology may be used, either as a primary technique or in combination with prioritization (e.g., see FIG. 5) or other techniques, to develop a candidate set of ad lines from which selection takes place using another selection mechanism (e.g., randomness).

### Prioritization

FIG. 5 illustrates a method for determining a priority value for individual ad lines that comprise an inventory of ad lines, according to one or more embodiments. The priority values for individual ad lines may enable a priority schema to facilitate selection of ad lines to serve ad request. A prioritization technique such as described by an embodiment of FIG. 5 may be used as either a primary or supplemental mechanism for selecting ad lines to serve ad requests. For example, a prioritization technique such as described by an embodiment of FIG. 5 may be employed to select ad lines in response to ad requests, provided that the selection of the ad line complies with other selection parameters or rules, such as contextual or non-contextual requirements of individual ad lines. As an alternative addition, prioritization may be used to develop a set of candidate ad lines, from which a selection technique (e.g., randomness) is used to select ad lines for serving ad request.

Still further, as described with an embodiment of FIG. 3, prioritization may be combined with ranking in order to facilitate the selection of individual ad lines to serve ad requests. For example, a prioritization methodology such as described by FIG. 5 may be nested within a ranking methodology, as part of an algorithm to select ad lines, or to select ad lines for random selection (e.g., see FIG. 3). In variations, a ranking methodology may be nested within a prioritization methodology to select ad lines, or identify a candidate set of ad lines.

According to embodiments, a scoring system is used to determine a priority value for an ad line. In an embodiment, a score component is determined from a classification of the ad line as to the ad lines requirements for generating delivery units (510). In one implementation, the classifications for an ad line includes: (i) guaranteed (512), meaning the ad line includes an obligation by the operator of system 100 to provide a certain number of delivery units, without compromise; (ii) non-guaranteed (514), meaning the ad line includes a best or reasonable effort requirement to provide a certain number of delivery units; and (iii) remnant (516), meaning the ad line is selected on a limited basis, such as when no other ad line is required to be served.

In addition to the score component determined from the ad line classification, one or more prioritization sub-values may be used to determine a score component for the priority value of an individual ad line (520). Accordingly, under some embodiments, the priority value for individual ad lines may factor: (i) the ad line classification as to parameters such as the rigidity or requirements for success (e.g., guaranteed versus targeted or remnant, as described in (510)) (ii) parameter(s) associated with the ad line relating to the ad line's use on a target network location (522) (e.g., an ad line requirement for selection only on a designated domain or website), (iii) parameter(s) associated with the ad line relating to the ad line's target audience (524) (e.g., an ad line requirement for selection only to a specific user profile, such as gender and age group); and/or (iv) parameter(s) associated timing (526), such as the start/end date of the ad line, or the availability (or lack thereof) of the timeline at certain times.

Still further, one or more embodiments include parameters such as network tier (532), exclusivity value (534), scarcity value (536), monetization (538) and/or the end date (540). The network tier value 532 is indicative of (i) a set of channels on the network that the advertisement line is distributed on, and/or (ii) a value associated with each channel in the set. The exclusivity value (534) is based on whether the advertisement line is served exclusively to (i) a contextual resource of the network, and/or (ii) a class of targets in an audience of the network. The scarcity value (536) is indicative of a relative scarcity of an intended class of targets for the advertisement line. Monetization (538) reflects a value of the delivery unit provided from the ad line, such as the cost-per-impression or cost-per-click. The end time value (540) identifies an end date associated with the advertisement line.

The ad line prioritization value is determined from the score components (550), such as the score component for the ad line's classification (see (510)) and for the various sub-values (see (520)).

According to some embodiments, the prioritization value may weigh the score components that form the basis of the prioritization value. The weighting to the score components of the prioritization value may be determined from default weighting (552), or programmatic or manual input (554). For example, the weighting may be adjusted programmatically or manually by the operator of system 100 in order to accommodate traffic conditions, specific advertiser demands or other conditions. As an addition or alternative, one web site may select to weigh some values differently than another web site. Alternatively, some advertisers may have right to prioritize their respective ad line. Numerous conditions or triggers may be employed to weight weigh one or more of the sub-values or parameters described herein. The prioritization value for the individual ad lines can then be used to determine the prioritization schema (560).

Hardware System Description

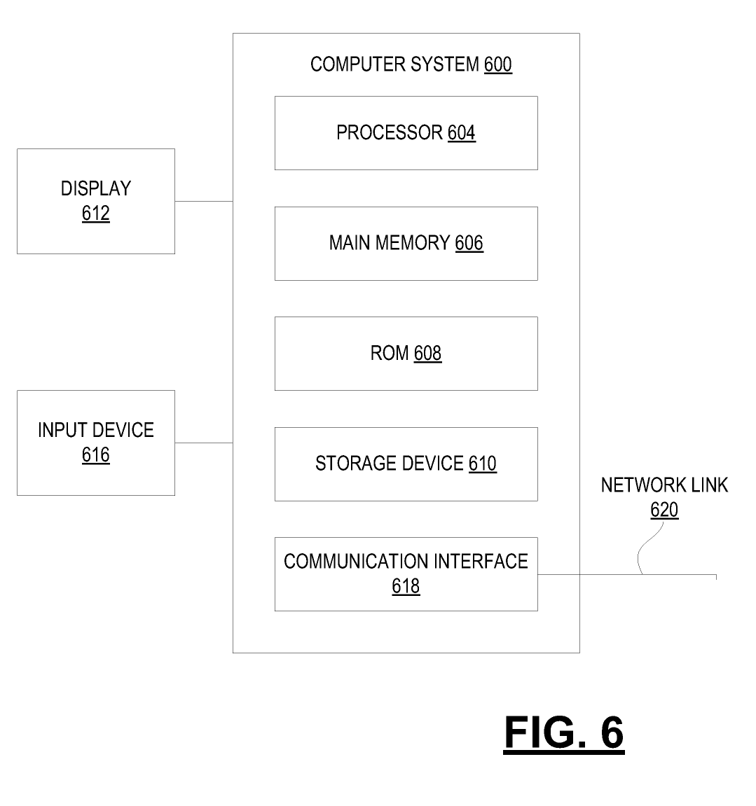

FIG. 6 is a block diagram that illustrates a computer system upon which embodiments described herein may be implemented. For example, in the context of FIG. 1, system 100 may be implemented using a computer system such as described by FIG. 6.

In an embodiment, computer system 600 includes processor 604, main memory 606, ROM 608, storage device 610, and communication interface 618. Computer system 600 includes at least one processor 604 for processing information. Computer system 600 also includes a main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) 608 or other static storage device for storing static information and instructions for processor 604. A storage device 610, such as a magnetic disk or optical disk, is provided for storing information and instructions. The communication interface 618 may enable the computer system 600 to communicate with one or more networks through use of the network link 620.

Computer system 600 can include display 612, such as a cathode ray tube (CRT), a LCD monitor, and a television set, for displaying information to a user. An input device 614, including alphanumeric and other keys, is coupled to computer system 600 for communicating information and command selections to processor 604. Other non-limiting, illustrative examples of input device 614 include a mouse, a trackball, or cursor direction keys for communicating direction information and command selections to processor 604 and for controlling cursor movement on display 612. While only one input device 614 is depicted in FIG. 6, embodiments may include any number of input devices 614 coupled to computer system 600.

Embodiments described herein are related to the use of computer system 600 for implementing the techniques described herein. According to one embodiment, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-implemented method for delivering advertisements over a network, the method being implemented by one or more processors and comprising:
(a) determining a total number of advertisement units that are to be generated for an advertisement line over a duration of time that includes a defined start time and a defined end time;
(b) determining, for each of a plurality of time segments that comprise the duration of time, a required portion of the total number of advertisement units, the required portion being based on a proportionate distribution of at least some of the total number of advertisement units over each of the plurality of time segments;
(c) at a given instance in the duration of time, determining at least one of an actual deficit or predicted deficit to the total number of advertisement units; and
(d) managing delivery of advertisement content that generate advertisement units for the advertisement line by (i) assigning a higher priority to delivering advertisement content in each time segment to generate the required portion of the total number of advertisement units, and (ii) assigning a lower priority to delivering creates in each time segment to generate a surplus to the required portion, the surplus being counted against the deficit to the total number of advertisement units.

2. The method of claim 1, wherein determining the deficit includes determining the actual deficit based at least in part on an actual start time for the advertisement line being late as compared to the designated start time.

3. The method of claim 1, wherein determining the deficit includes determining the actual deficit as a result of the required portion of the total number of advertisement units not being generated in one or more prior time segments.

4. The method of claim 1, wherein determining the deficit includes determining the predicted deficit based on a prediction that the required portion of the total number of advertisement units will not be generated in one or more upcoming time segments.

5. The method of claim 1, wherein at least steps (c) and (d) are performed multiple instances in the designated duration of time.

6. The method of claim 1, wherein determining the required portion further comprises (i) determining an overloaded portion of the total number of advertisement units that are to be asymmetrically distributed over an overloaded time period within the designated duration of time, (ii) distributing a number of advertisement content on the network for generating the overloaded portion of advertisement units during the overloaded time period, so that the required portion for each time segment in the overloaded time period is different than the required portion for each time segment that is not in the overloaded time period.

7. The method of claim 6, wherein determining an overloaded portion of the total number of advertisement units includes determining a portion of the total number of advertisement units for a front portion of the designated time period.

8. The method of claim 1, further comprising determining a portion of the deficit that should be delivered over each time period.

9. A system for delivering advertisements over a network, the system comprising:
a memory that stores instructions;
one or more processors that communicate with the memory, in order to execute instructions for performing operations that include:
(a) determining a total number of advertisement units that are to be generated for an advertisement line over a duration of time that includes a defined start time and a defined end time;
(b) determining, for each of a plurality of time segments that comprise the duration of time, a required portion of the total number of advertisement units, the required portion being based on a proportionate distribution of at least some of the total number of advertisement units over each of the plurality of time segments;
(c) at a given instance in the duration of time, determining at least one of an actual deficit or predicted deficit to the total number of advertisement units; and
(d) managing delivery of advertisement content that generate advertisement units for the advertisement line by (i) assigning a higher priority to delivering advertisement content in each time segment to generate the required portion of the total number of advertisement units, and (ii) assigning a lower priority to delivering advertisement content in each time segment to generate a surplus to the required portion, the surplus being counted against the deficit to the total number of advertisement units.

10. The system of claim 9, wherein determining the deficit includes determining the actual deficit based at least in part on an actual start time for the advertisement line being late as compared to the designated start time.

11. The system of claim 9, wherein determining the deficit includes determining the actual deficit as a result of the required portion of the total number of advertisement units not being generated in one or more prior time segments.

12. The system of claim 9, wherein determining the deficit includes determining the predicted deficit based on a prediction that the required portion of the total number of advertisement units will not be generated in one or more upcoming time segments.

13. The system of claim 9, wherein the operations of (c) and (d) are performed multiple instances in the designated duration of time.

14. The system of claim 9, wherein determining the required portion further comprises (i) determining an overloaded portion of the total number of advertisement units that are to be asymmetrically distributed over an overloaded time period within the designated duration of time, (ii) distributing a number of advertisement content on the network for generating the overloaded portion of advertisement units during the overloaded time period, so that the required portion for each time segment in the overloaded time period is different than the required portion for each time segment that is not in the overloaded time period.

15. The system of claim 9, wherein determining an overloaded portion of the total number of advertisement units includes determining a portion of the total number of advertisement units for a front portion of the designated time period.

16. The system of claim 9, further comprising determining a portion of the deficit that should be delivered over each time period.
